(19) United States
(12) Patent Application Publication
(10) Pub. No.: US 2020/0384404 A1
(43) Pub. Date: Dec. 10, 2020

(54) Emission Recovery System and Method

(71) Applicant: Joseph Pittman, Houston, TX (US)

(72) Inventor: Joseph Pittman, Houston, TX (US)

(21) Appl. No.: 16/433,557

(22) Filed: Jun. 6, 2019

(51) Int. Cl. B01D 47/06

(52) U.S. Cl. CPC B01D 47/06; B01D 46/0012

(57) ABSTRACT

Embodiments of an emission recovery system of the present invention generally include an inverted, substantially U-shaped tubular head, and a substantially straight, vertically oriented tubular body internally equipped with one or more fans and a plurality of liquid spray nozzles fluidly connected to a liquid provision system. Embodiments of a method of using an embodiment of an emission recovery system of the present invention are also provided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### FIELD OF THE INVENTION

The present invention generally relates to a system for removing impurities from an industrial vapor stream. More particularly, embodiments of the present invention are directed to an apparatus and a method for purifying a vapor stream using vacuum aspiration and liquid spray technologies.

### BACKGROUND OF THE INVENTION

Many industrial waste streams comprise components in a vapor phase. Often, the vapor stream comprises entrained liquid and/or solid components. Traditionally, vapor treatment devices (“scrubbers”) have been employed to remove undesired gaseous, liquid, and/or solid components from a waste vapor stream (i.e., “stack”). In various embodiments, these scrubbers may utilize filtration, temperature, vibration and/or liquid contact to effectuate purification of the vapor stream

### DESCRIPTION OF THE RELATED ART

Examples of vapor scrubbers may be found in U.S. Pat. No. 1,985,010 to Berkhuijsen; U.S. Pat. No. 2,215,707 to Matanovich et al.; U.S. Pat. No. 3,522,000 to Kinney; U.S. Pat. No. 3,616,597 to Stewart; U.S. Pat. No. 3,763,634 to Alliger; U.S. Pat. No. 5,298,043 to Mai et al.; and U.S. Pat. No. 9,897,313 to Jahchinedu, each of which is incorporated herein by reference in its entirety. While these and other vapor scrubbing systems may be useful, it is desired to provide an improved vapor scrubbing system.

### BRIEF SUMMARY OF THE INVENTION

Embodiments of an emission recovery system of the present invention generally include an inverted, substantially U-shaped tubular head, and a substantially straight tubular body internally equipped with one or more fans and a plurality of liquid spray nozzles. Embodiments of a method of using embodiments of an emission recovery system of the present invention are also provided.

### BRIEF DESCRIPTION OF THE DRAWINGS

For a more complete understanding of the present invention, reference is now made to the accompanying drawings, in which:

FIG. 1 is a side view of an embodiment of an emission scrubber system of the present invention.

FIG. 2 is a partially open side view of the embodiment of an emission scrubber system of the present invention depicted in FIG. 1.

### DETAILED DESCRIPTION OF EXEMPLARY EMBODIMENTS OF THE INVENTION

The exemplary embodiments are best understood by referring to the drawings, like numerals being used for like and corresponding parts of the various drawings. In the following description of embodiments, orientation indicators such as “top,” “bottom,” “up,’ “down,” “upper,” “lower,” “front,” “back,” etc. are used for illustration purposes only; the invention, however, is not so limited, and other possible orientations are contemplated.

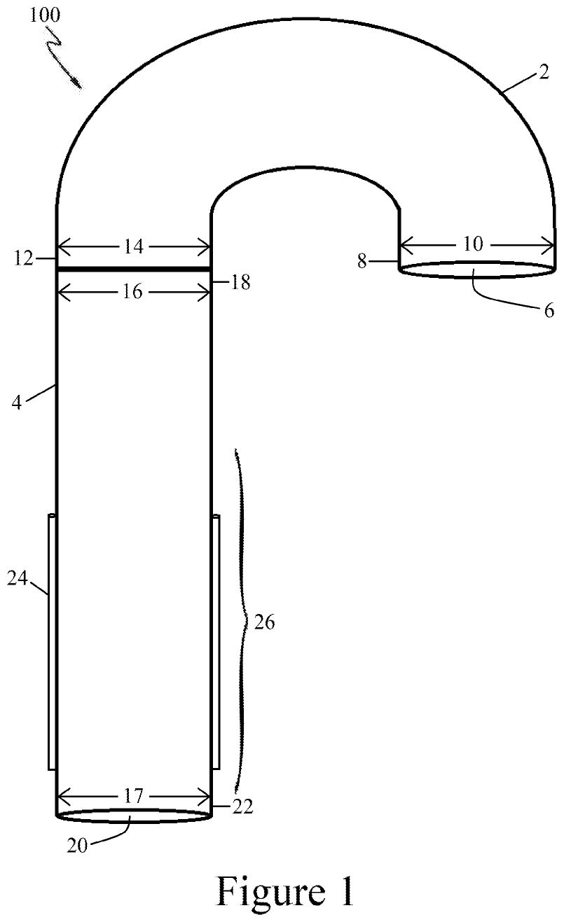

Referring first to FIG. 1, an embodiment of an emission recovery system 100 of the present invention is depicted. In one embodiment, emission recovery system 100 comprises an inverted, substantially U-shaped, substantially tubular head 2, and a substantially straight, substantially tubular, vertically oriented body 4. In one embodiment, head 2 comprises at least one inflow opening 6 proximate a first end 8 thereof. In one embodiment, inflow opening 6 provides an aperture across substantially the full internal diameter 10 of inflow opening 6, although the invention is not so limited and other configurations are contemplated. In one embodiment, head 2 comprises a single tubular component, but may comprise a plurality of members which can be cooperative arranged to provide head 2. In one embodiment, inflow opening 6 is sized and configured to operationally cooperate with a process off gas component (not shown), as is described in detail below.

In one embodiment, a second end 12 of head 2 is connected to body 4 so as to provide vapor flow there between, via a head 2 outflow opening (not visible in FIG. 1) and a body 4 inflow opening (not visible in FIG. 1). In one embodiment, an internal diameter 14 of second end 12 is substantially equal to an internal diameter 16 of a first end 18 of body 4, although the invention is not so limited and other configurations may be employed. In one embodiment, second end 12 of head 2 is removably attached to first end 18 of body 4, such as by bolts, screwed connection, and/or flanges (none of which shown), or other standard piping connection means, as would be understood by one skilled in the art. In one embodiment, head 2 may be integral to body 4.

In one embodiment, body 4 comprises a single tubular component, but may comprise a plurality of members which can be cooperative arranged to provide body 4. In one embodiment, body 4 comprises an outflow opening 20 proximate a second end 22 thereof. In one embodiment, body 4 comprises a substantially consistent internal and/or external diameter along the length thereof, wherein an internal diameter 17 of body 4 second end 22 is substantially equal to internal diameter 16 of body 4 first end 18. In other embodiments (not shown), body 4 may comprise other dimensional configurations.

In one embodiment, head 2 and/or body 4 may comprise a metal material, such as, but not limited to, stainless steel, carbon steel, or aluminum. In various embodiments, head 2 and/or body 4 may comprise a natural or synthetic polymeric material, graphite material, or other useful material as would be understood by one skilled in the art. In one embodiment, head 2 and/or body 4 may be internally coated with corrosion resistant and/or desired coating material(s), as would be understood by one skilled in the art.

In one embodiment, body 4 is equipped with a liquid provision system 24. In one embodiment, liquid provision system 24 comprises tubing configured and adapted to transport a liquid (not shown) to emission recovery system 100. In one embodiment, liquid provision system 24 is connectable to, and fluidly communicative with, a liquid source (not shown). In one embodiment, at least a portion of liquid provision system 24 is disposed proximate a lower section 26 of body 4.

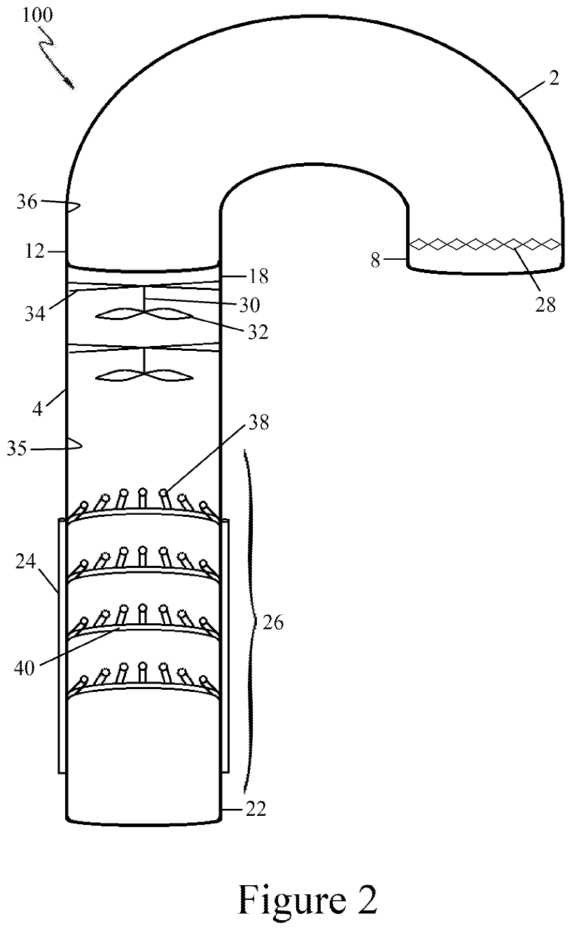

Referring now to FIG. 2, a partially open side view of the FIG. 1 embodiment of an emission recovery system 100 of the present invention is depicted. In one embodiment, one or more solids exclusion components 28 is/are positioned within head 2 proximate first end 8 thereof. In one aspect, a solids exclusion component 28 is adapted and configured to provide a means of preventing relatively large objects from entering emission recovery system 100. In one embodiment, solids exclusion component 28 may comprise louvers, a mesh, and/or packing material, as would be understood by one skilled in the art.

As further shown in FIG. 2, emission recovery system 100 is equipped with one or more fans 30. In one embodiment, a least one fan 30 is positioned within first end 18 of body 4. In one embodiment (not shown) one or more fans 30 may be positioned within second end 12 of head 2. In still other embodiments (not shown), emission recovery system 100 may be equipped with one or more fans 30 positioned within body 4 and one or more fans positioned within head 2.

In one embodiment, as depicted in FIG. 2, a fan 30 may be a standard gas flow creation component comprising a plurality of rotating blades 32 positioned within body 4 (and/or head 2). In one embodiment, a fan 30 is suspended from a support structure 34 disposed within body 4 (and/or head 2). In such an embodiment, energy utilized to drive the fan 30 (typically electrical energy, but could be, for example, pneumatic of hydraulic) may be provided from a source (not shown) external or internal to emission recovery system 100. In one embodiment, support structure 34 is equipped with electrical cabling (not shown) used to drive a fan 30.

In one embodiment (not shown), a fan 30 may comprise a “bladeless” fan, such disclosed in U.S. Pat. Nos. 8,052,379, 8,308,445 and 8,454,322 to Gammack, U.S. Pat. Nos. 8,348,629, 8,403,650, 8,469,658, 8,764,412, 8,784,049, 9,249,810, 10,006,657 and 10,221,860 to Gammack et al., U.S. Pat. Nos. 9,816,531 and 10,145,388 to Simmonds et al., U.S. Pat. Nos. 7,391,449 and 8,348,629 to Fitton et al., U.S. Pat. No. 9,745,981 to Dos Rios et al., and/or Japanese Patent Application Publication JPS56167897(A) by Okabe et al., each of which is incorporated herein by reference in its entirety. In one such embodiment, the central (circular) portion (also referred to as the annular “nozzle”) of the fan 30 is disposed circumferentially proximate, or at least partially within, an interior wall 35 of body 4 (and/or an interior wall 36 of head 2), as would be understood by one skilled in the art. Further, in various embodiments, additional components of the “bladeless” fan 30, including, but not limited to, air inlet apertures, may be contained at least partially within emission recovery system 100, including, but not limited to, interior walls 35 and/or 36 (which may comprise hollow portions having internal cavities, compartments, or the like which are in fluid communication with fan 30), and/or at least portions of such additional components may be disposed at least partially exterior to emission recovery system 100.

Still referring to FIG. 2, emission recovery system 100 is equipped with a plurality of nozzles 38. In one embodiment, a nozzle 38 comprises a component configured and adapted to spray liquid into the interior of body 4. In various embodiments, nozzles 38 may be adapted and configured to produce a sprayed liquid ranging from a fine mist (i.e., “atomized”) to large droplets as is desired, as would be understood by one skilled in the art. A plurality of nozzles 38 may be adapted and configured to produce similar or different sprays. In one embodiment, each nozzle 38 is fluidly connected, directly or indirectly, to liquid provision system 24. In one embodiment, liquid provision system 24 comprises one or more tubular members 40 to which a nozzle 38 may be fluidly connected. In one embodiment, at least one tubular member 40 extends circumferentially horizontally about the interior of body 4 proximate or integral with interior wall 35 thereof. In various embodiments, emission recovery system 100 may comprise a plurality of such tubular members 40, each equipped with a plurality of nozzles, as depicted in FIG. 2.

In one embodiment, one or more nozzles 38 are oriented at least somewhat upward (i.e., toward first end 18 of body 4). In one embodiment, one or more nozzles 38 are disposed upward at an angle of about 80 degrees with respect to the longitudinal axis of body 4. In one embodiment, nozzles 38 may comprise a metal material, such as, but not limited to, stainless steel, carbon steel, or aluminum. In various embodiments, nozzles 38 may comprise a natural or synthetic polymeric material, graphite material, or other useful material as would be understood by one skilled in the art. In one embodiment, each of the plurality of nozzles 38 may comprise the same internal or external dimensions, spray angle, and/or material of construction, or may vary in one or more of these characteristics.

### Operation

Generally, an emission recovery system 100 may be utilized to treat process off gases, i.e., waste vapor streams from industrial processes, although the invention is not so limited and may be employed in conjunction with any gaseous stream. In one embodiment, an emission recovery system 100 head 2 is positioned such that inflow opening 6 is disposed proximate or in attached fluid connection to a process off gas source (not shown). In one embodiment, the head 2 is so positioned and then the body 4 is attached to the head 2 in the configuration depicted in the embodiments of FIGS. 1 and 2. In another embodiment, the emission recovery system 100, comprising both the head 2 and body 4 is provided such that inflow opening 6 is disposed proximate or in attached fluid connection to the process off gas source (not shown). In one aspect, an emission recovery system 100 is “portable,” in that it may be transported (as a single component or in sections) to a desired location where it can be cooperatively engaged with a waste gas stack and operated as describe herein.

In one embodiment, once the emission recovery system 100 is provided as described above, liquid (not shown) from a liquid source (not shown) is provided to liquid provision system 24 such that the liquid flows there through and liquid is expelled from one or more of the nozzles 38. In this fashion, the liquid is sprayed within body 4 inward from the nozzles 38. After or concurrently with commencement of liquid spray via nozzles 38, at least one of the one or more fans 30 is actuated. Actuation of the fan(s) 30 creates a downward (toward the second end 22 of body 4) air flow, which creates an internal negative pressure (vacuum) with respect to at least head 2, and causes aspiration of the process off gas into head 2 through inflow opening 6.

In one embodiment, the process off gas is aspirated into head 2 through inflow opening and a solids exclusion component 28 serves to prevent large entrained solid particles or objects from moving onward through head 2. In this aspect, solids exclusion component 28 functions to “knock down” such solids. As the process off gas is aspirated further into emission recovery system, it flows past the fan(s) 30 and downward through body 4, where it comes into contact with the liquid being sprayed through nozzles 38.

In various embodiments, the liquid utilized by liquid provision system may comprise aqueous and/or non-aqueous liquid(s). In one embodiment, the liquid is water. In other embodiments, the liquid comprises an aqueous solution or mixture. In various embodiments the liquid comprises a pH acidic or pH basic material. In various embodiments the liquid comprises a material comprising organic solvents and/or reagents. In one embodiment, a liquid provision system 24 may comprise fluidly segregated sections and/or piping whereby different liquids may be provided to nozzles 38; e.g., a first liquid can be sprayed from one set of nozzles 38 and another liquid can be sprayed from another set of nozzles 38.

Once the off gas has come into contact with the liquid sprayed from nozzles 38, the liquid waste stream (not shown) (comprising whatever materials from the off gas that have been solvated, dissolved, entrained, etc. by the liquid) and the residual gas exists emission recovery system 100 via body 4 outflow opening 20. Upon exiting the emission recovery system 100, the liquid waste stream may be collected or otherwise handled as would be understood by one skilled in the art.

### Method

An exemplary method of utilizing an embodiment of an emission recovery system 100 of the present invention comprises:

An Emission Recovery System Provision Step, comprising providing an emission recovery system, such as emission recovery system 100, proximate a source of gas to be treated, wherein an inflow opening of the emission recovery system, such as inflow opening 6, is positioned such that gas from the source can flow into the inflow opening;

An Emission Recovery System Setup Step, comprising fluidly connecting a source of liquid to a liquid provision system of the emission recovery system, such as liquid provision system 24, and connecting a power source to one or more fans of the emission recovery system, such as a fan 30;

An Emission Recovery System Operation Step; comprising actuating the fan(s) and flowing liquid through the liquid provision system to a plurality of nozzles, such as a nozzle 38, to effectuate spraying of the liquid within the emission recovery system, wherein gas from the source is aspirated into the emission recovery system, and liquid waste and treated gas exits the emission recovery system through an outflow opening thereof, such as outflow opening 20.

The foregoing method is merely exemplary, and additional embodiments of a method of utilizing an emission recovery system of the present invention consistent with the teachings herein may be employed. In addition, in other embodiments, one or more of these steps may be performed concurrently, combined, repeated, re-ordered, or deleted, and/or additional steps may be added.

The foregoing description of the invention illustrates exemplary embodiments thereof. Various changes may be made in the details of the illustrated construction and process within the scope of the appended claims by one skilled in the art without departing from the teachings of the invention. Disclosure of existing patents, publications, and/or known art incorporated herein by reference is to the extent required to provide details and understanding of the disclosure herein set forth. The present invention should only be limited by the claims and their equivalents.

I claim:

1. An emission recovery system comprising:
an inverted, substantially u-shaped head;
a vertical, substantially tubular body;
one or more fans;
a liquid provision system, and
a plurality of internal, inwardly directed nozzles;
wherein:
said head comprises a fluid inflow opening at a first end thereof;
said body comprises a fluid outflow opening at a second end thereof;
a second end of said head is attached to and fluidly communicative with a first end of said body;
said fans are disposed within said emission recovery system intermediate said inlet flow opening and said nozzles;
said fans direct gas flow downward;
said nozzles are disposed within said body;
said liquid provision system provides liquid to said nozzles; and
said nozzles spray liquid within said emission recovery system at least partially upward toward said fans;
wherein:
gas to be treated enters said emission recovery system through said fluid inflow opening;
said fans aspirate said gas through said head and into said body;
said gas flows past said fans downward toward said nozzles;
said gas passes through said upwardly sprayed liquid; and
said gas exits said emission recovery system downward through said body fluid outflow opening.

2. The emission recovery system of claim 1, wherein at least one said fan is a bladeless fan.

3. The emission recovery system of claim 1, wherein at least one of said nozzles directs a spray of liquid at an angle of about 80 degrees with respect to the longitudinal axis of said body.

4. The emission recovery system of claim 1, comprising a plurality of fans.

5. The emission recovery system of claim 1, wherein said plurality of nozzles is positioned circumferentially horizontally about an internal surface of said body.

6. The emission recovery system of claim 1, comprising a solids exclusion component positioned within said head proximate said fluid inflow opening.

7. The emission recovery system of claim 1, wherein all of said fans are positioned at least partially within said body.

8. A method of utilizing an emission recovery system, comprising:
providing the emission recovery system of claim 1 proximate a source of gas to be treated, wherein said gas can be directed upward into said fluid inflow opening;
operating said liquid provision system such that one or more liquids are sprayed at least partially upward from said nozzles; and
operating said fans such that:
said gas is aspirated through said head;
said gas flows downward past said fans;
said gas is contacted by said upwardly sprayed liquid; and
said gas exits said emission recovery system downward through said body fluid outflow opening.

9. The method of claim 8, wherein at least one of said liquids comprises water.

10. The method of claim 8, wherein at least one said fan is a bladeless fan.

11. The method of claim 8, wherein at least one of said nozzles directs a spray of liquid at an angle of about 80 degrees with respect to the longitudinal axis of said body.

12. The method of claim 8, wherein said emission recovery system comprises a plurality of fans.

13. The method of claim 8, wherein said plurality of nozzles is positioned circumferentially horizontally about an internal surface of said body

14. The method of claim 8, wherein said emission recovery system comprises a solids exclusion component positioned within said head proximate said fluid inflow opening.

15. The method of claim 8, wherein all of said fans are positioned at least partially within said body.

16. A method of utilizing an emission recovery system, comprising:
providing an inverted, substantially u-shaped head proximate a source of gas to be treated, wherein said gas can be directed upward into a fluid inflow opening at a first end of said head;
attaching a first end of a substantially tubular body vertically to and in fluid communication with a second end of said head to provide said emission recovery system;
wherein:
said body comprises a fluid outflow opening at a second end thereof;
a plurality of internal, inwardly directed nozzles in fluid communication with a liquid provision system is provided within said body; and
one or more fans are disposed within said emission recovery system intermediate said inlet flow opening and said nozzles;
operating said liquid provision system such that one or more liquids are sprayed at least partially upward from said nozzles; and
operating said fans such that:
said gas is aspirated through said head;
said gas flows downward past said fans;
said gas is contacted by said upwardly sprayed liquid; and
said gas exits said emission recovery system downward through said body fluid outflow opening.

17. The method of claim 16, wherein at least one said fan is a bladeless fan.

18. The method of claim 16, wherein at least one of said nozzles directs a spray of liquid at an angle of about 80 degrees with respect to the longitudinal axis of said body.

19. The method of claim 16, wherein said emission recovery system comprises a plurality of fans.

20. The method of claim 16, wherein all of said fans are positioned at least partially within said body.
